(19) United States
(12) Patent Application Publication
(10) Pub. No.: US 2005/0268778 A1
(43) Pub. Date: Dec. 8, 2005

(54) Flow control device for pneumatic tool

(75) Inventor: Ching-Shun Chang, Taichung (TW)

Correspondence Address: BACON & THOMAS, PLLC, 625 SLATERS LANE, FOURTH FLOOR, ALEXANDRIA, VA, 22314, US

(73) Assignee: Hsiu-Ju Chen, TAICHUNG (TW)

(21) Appl. No.: 11/133,382

(22) Filed: May 20, 2005

(30) Foreign Application Priority Data
Jun. 4, 2004 (TW) 93208913

(51) Int. Cl. B60H 1/00; B64D 13/00

(52) U.S. Cl. 91/418; 91/469

(57) ABSTRACT

A flow control device for use in a pneumatic tool is disclosed to include an air connector, which has a first bearing portion, a sealing portion, a second bearing portion, an air inlet, and an air outlet, a control socket, which is threaded onto the air connector and has a first bearing portion, a sealing portion, and a second bearing portion, a first seal for sealing the gap between the first bearing portion of the air connector and the first bearing portion of the control socket, a second seal for sealing the gap between the second bearing portion of the air connector and the second bearing portion of the control socket, and a flow-control seal for sealing the gap between the sealing portion of the control socket and the sealing portion of the air connector and for regulating the flow rate of a compressed air passing from the air inlet toward the air outlet upon rotation of the control socket relative to the air connector.

### BACKGROUND OF THE INVENTION

1. Field of the Invention

The present invention relates to a pneumatic tool and more particularly, to a flow control device for pneumatic tool.

2. Description of the Related Art

The flow control device of a conventional pneumatic tool commonly uses a rotary control member to match with a holding down spring for controlling the flow of air. Due to change of sealing condition upon adjustment, this design of flow control device cannot accurately achieve the desired flow control. Further, the parts of the flow control device may not fit one with another tightly after a long use of the pneumatic tool, resulting in inaccurate or ineffective flow control.

### SUMMARY OF THE INVENTION

The present invention has been accomplished under the circumstances in view. It is the main object of the present invention to provide a flow control device for pneumatic tool, which can conveniently be operated to regulate the flow rate of air rapidly. It is another object of the present invention to provide a flow control device for pneumatic tool, which controls the flow rate of air accurately. It is still another object of the present invention to provide a flow control device for pneumatic tool, which has a simple and steady structure, and is easy to assemble.

To achieve these and other objects of the present invention, the flow control device comprises an air connector, the air connector having a first male screw portion, a first bearing portion, a sealing portion, a second bearing portion, an air inlet extending from one end to the periphery thereof between the first bearing portion and sealing portion of the air connector, and an air outlet extending from the periphery thereof between the sealing portion and second bearing portion of the air connector to the other end; a control socket, the control socket having a first female screw portion threaded onto the first male screw portion of the air connector, a first bearing portion, a sealing portion, and a second bearing portion; a first seal adapted to seal the gap between the first bearing portion of the air connector and the first bearing portion of the control socket; a second seal adapted to seal the gap between the second bearing portion of the air connector and the second bearing portion of the control socket; and a flow-control seal adapted to seal the gap between the sealing portion of the control socket and the sealing portion of the air connector, the flow-control seal being movable between the air inlet and the air outlet to regulate the flow rate of a compressed air passing between the air inlet and the air outlet upon rotation of the control socket relative to the air connector.

### BRIEF DESCRIPTION OF THE DRAWINGS

FIG. 1 is a schematic drawing showing a flow control device installed in a pneumatic tool according to a first embodiment of the present invention.

FIG. 2 is an exploded view in section of the flow control device according to the first embodiment of the present invention.

FIG. 3 is a schematic sectional view of the first embodiment of the present invention, showing the air passage between the air inlet and the outer outlet closed.

FIG. 4 is similar to FIG. 3 but showing the air passage between the air inlet and the air outlet opened.

FIG. 5 is a schematic sectional view showing a flow control device constructed according to a second embodiment of the present invention.

FIG. 6 is a schematic sectional view showing a flow control device constructed according to a third embodiment of the present invention.

FIG. 7 is a schematic sectional view showing a flow control device constructed according to a fourth embodiment of the present invention.

FIG. 8 is a schematic sectional view showing a flow control device constructed according to a fifth embodiment of the present invention.

FIG. 9 is a schematic sectional view showing a flow control device constructed according to a sixth embodiment of the present invention.

FIG. 10 is a schematic sectional view showing a flow control device constructed according to a seventh embodiment of the present invention.

### DETAILED DESCRIPTION OF THE INVENTION

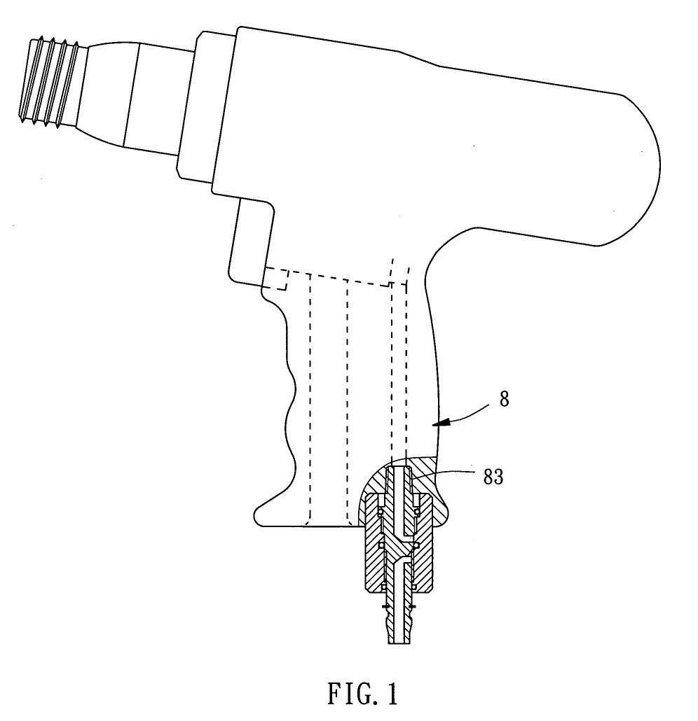

Referring to FIG. 1, a flow control device in accordance with a first embodiment of the present invention is shown used in a pneumatic tool 8, which has a receiving portion 83 that is a screw hole.

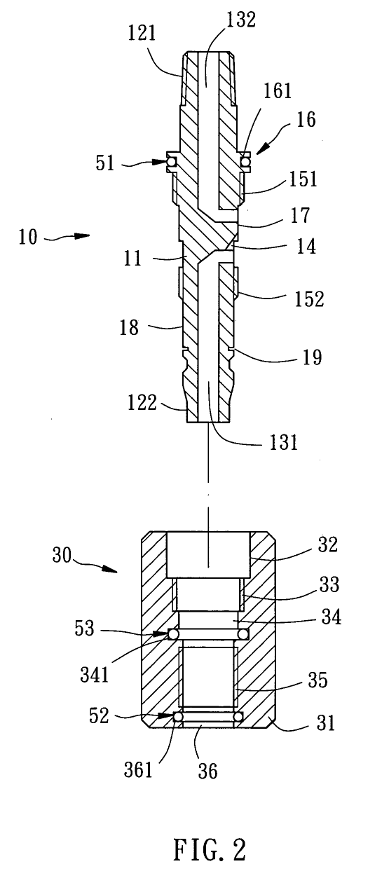

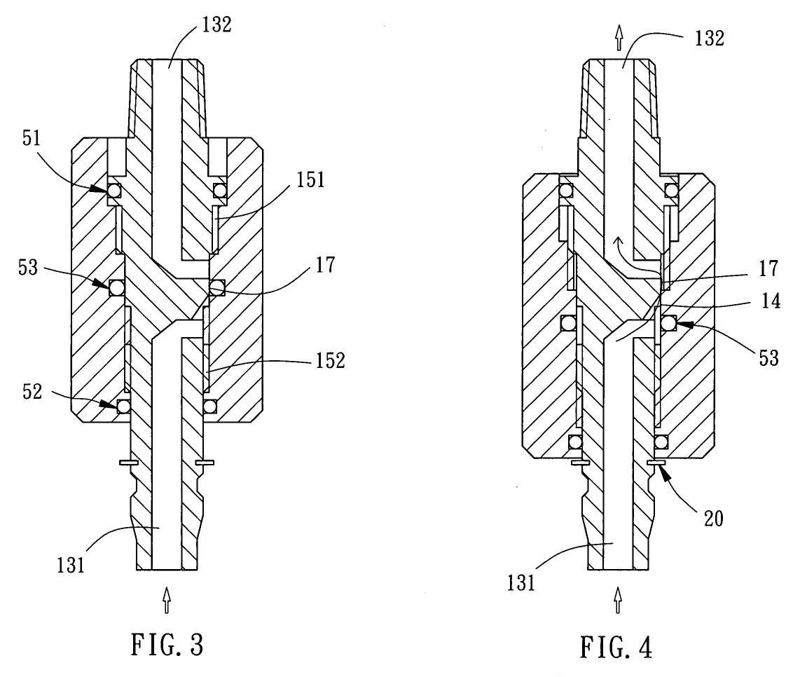

Referring to FIGS. 2 and 3, the flow control device comprises:

An air connector 10, which has a tubular body 11, first connecting means (for example, an outer thread) 121 fixedly provided at one end of the tubular body 11 and fastened to the receiving portion 83 of the pneumatic tool 8, second connecting means 122 fixedly provided at the other end of the tubular body 11 and fastened to the quick connector (not shown) of air pumping means (not shown), an air inlet 131 and an air outlet 132 respectively axially extending from the two distal ends of the tubular body 11 to the periphery, and an air passage 14 obliquely formed in the peripheral wall of the tubular body 11 in communication with the air inlet 131, a first male screw portion 151 and a second male screw portion 152 formed integral with the peripheral wall of the tubular body 11, a first bearing portion 16 extending around the peripheral wall of the tubular body 11 and spaced between the first male screw portion 151 and the first connecting means 121, a mounting groove 161 formed in the first bearing portion 16 around the peripheral wall of the tubular body 11, a sealing portion 17 formed integral with the peripheral wall of the tubular body 11 and spaced between the first male screw portion 151 and the second male screw portion 152, a second bearing portion 18 formed integral with the peripheral wall of the tubular body 11 and spaced between the second male screw portion 152 and the second connecting means 122, and a retaining groove 19 extending around the peripheral wall of the tubular body 11 and spaced between the second bearing portion 18 and the second connecting means 122.

A retainer 20 fastened to the retaining groove 19 around the peripheral wall of the tubular body 11 of the air connector 10.

A control socket 30, which has a socket body 31, a first bearing portion 32 formed in one end of the inside wall of the socket body 31, a first female screw portion 33 formed in the inside wall of the socket body 31 and abutted against the first bearing portion 32 for threading onto the first male screw portion 151 of the air connector 10, a sealing portion 34 formed integral with the inside wall of the socket body 31 corresponding to the sealing portion 17 and the air passage 14 of the air connector 10, a mounting groove 341 extending around the sealing portion 34, a second female screw portion 35 formed in the inside wall of the socket body 31 for threading onto the second male screw portion 152 of the air connector 10, a second bearing portion 36 formed in the other end of the inside wall of the socket body 31, and a mounting groove 361 extending around the second bearing portion 36.

A first seal 51 mounted in the mounting groove 161 in the first bearing portion 16 of the air connector 10 and pressed on the first bearing portion 32 of the control socket 30.

A second seal 52 mounted in the mounting groove 361 in the second bearing portion 36 of the control socket 30 and pressed on the second bearing portion 18 of the air connector 10.

A flow-control seal 53 mounted in the mounting groove 341 in the sealing portion 34 of the control socket 30 and movably pressed on between the air passage 14 and sealing portion 17 of the air connector 10.

Referring to FIG. 3, the flow-control seal 53 is mounted in the mounting groove 341 of the control socket 30 and pressed on the sealing portion 17 of the air connector 10, it blocks the passage between the air inlet 131 and the air outlet 132, and therefore compressed air which is guided into the air inlet 131 cannot pass to the air outlet 132.

Referring to FIG. 4, when rotating the control socket 30 relative to the air connector 10, the first female screw portion 33 and the second female screw portion 35 are respectively moved relative to the first male screw portion 151 and the second male screw portion 152, and therefore the control socket 30 is moved axially relative to the air connector 10 to carry the flow-control seal 53 toward the air passage 14 and to gradually open the air passage 14, enabling compressed air to pass from the air inlet 131 to the air outlet 132. Therefore, by means of rotating the control socket 30 relative to the air connector 10, the flow rate of compressed air is relatively regulated.

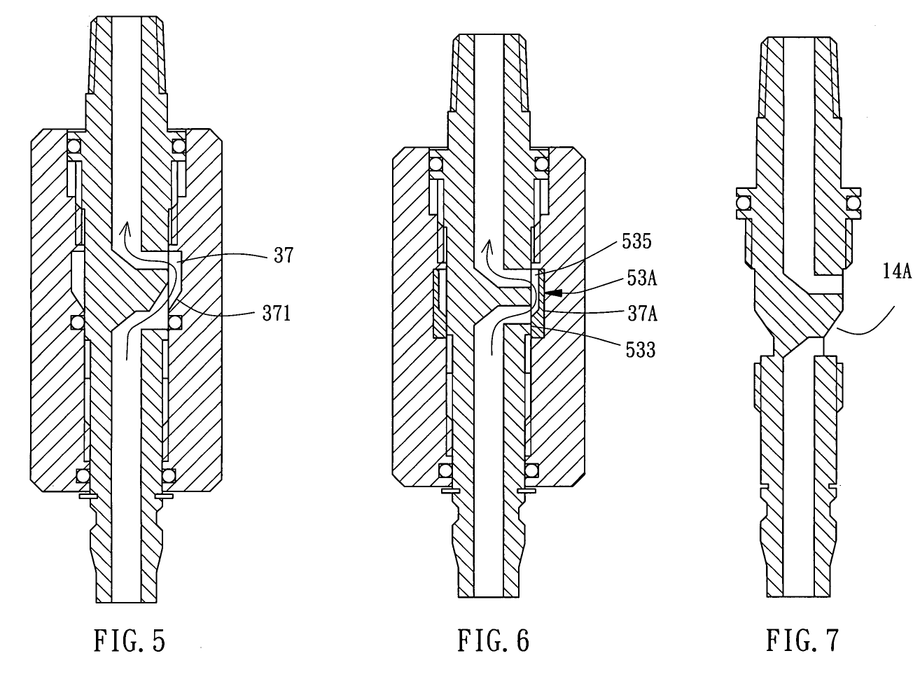

FIG. 5 shows a flow control device constructed according to a second embodiment of the present invention. According to this embodiment, the control socket has an inside groove 37 and a sloping inside wall portion 371 at one side of the inside groove 37 corresponding to the air passage of the air connector for guiding compressed air from the air inlet to the air outlet.

FIG. 6 shows a flow control device constructed according to a third embodiment of the present invention. According to this embodiment, the air passage is eliminated from the air connector, the control socket has an inside groove 37A, and the flow-control seal 53A is mounted in the inside groove 37A. The flow-control seal 53A has a flanged sealing portion 533 at one side, and defines an air passage 533 for guiding compressed air out of the air inlet into the air outlet.

FIG. 7 shows a flow control device constructed according to a fourth embodiment of the present invention. According to this embodiment, the air passage 14A extends around the periphery of the air connector and sloping in one direction.

Further, the first seal and second seal can be mounted one in the groove of the control socket and the other in the groove of the air connector, or the first seal and second seal can be mounted both in the groove of the air connector or both in the groove of control socket.

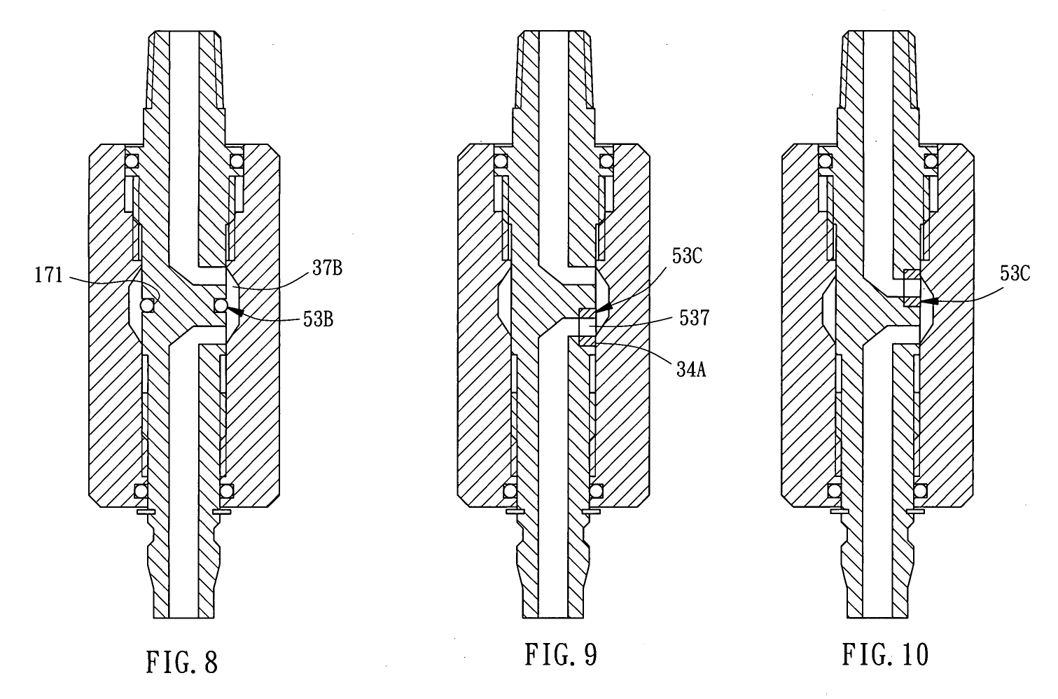

FIG. 8 shows a flow control device constructed according to a fifth embodiment of the present invention. According to this embodiment, the flow-control seal 53B is mounted in an outside annular groove 171 around the periphery of the tubular body of the air connector, and the control socket has an air passage 37B for guiding compressed air from the air inlet to the air outlet.

FIG. 9 shows a flow control device constructed according to the sixth embodiment of the present invention. According to this embodiment, the flow-control seal 53C is mounted in one end of the air inlet in the peripheral wall of the tubular body of the air connector and having a through hole 537; the control socket has a sealing portion 34A movable with the control socket relative to the tubular body of the air connector to control the opening of the through hole 537 and to further control the flow rate of compressed air passing out of the air inlet to the air outlet.

FIG. 10 shows a flow control device constructed according to the seventh embodiment of the present invention. According to this embodiment, the flow-control seal 53C is mounted in one end of the air outlet in the peripheral wall of the tubular body of the air connector.

As indicated above, the present invention provides a flow control device, which has the following characteristics:

b 1. By means of rotating the control socket relative to the air connector to move the control socket axially relative to the air connector, the flow rate is relatively controlled.

2. By means of rotating the control socket relative to the air connector, the flow-control seal is moved to control the opening of the air passage between the air inlet and the air outlet, thereby regulating the flow rate accurately.

3. The whole structure of the flow control device is simple and steady, and the flow control operation is simple and easy.

1. A flow control device comprising:
an air connector, said air connector having a first male screw portion, a first bearing portion, a sealing portion, a second bearing portion, an air inlet extending from one end to the periphery thereof between said first bearing portion and sealing portion of said air connector, and an air outlet extending from the periphery thereof between said sealing portion and second bearing portion of said air connector to the other end;
a control socket, said control socket having a first female screw portion threaded onto said first male screw portion of said air connector, a first bearing portion, a sealing portion, and a second bearing portion;
a first seal adapted to seal the gap between said first bearing portion of said air connector and said first bearing portion of said control socket;
a second seal adapted to seal the gap between said second bearing portion of said air connector and said second bearing portion of said control socket; and
a flow-control seal adapted to seal the gap between said sealing portion of said control socket and said sealing portion of said air connector, said flow-control seal being movable between said air inlet and said air outlet to regulate the flow rate of a compressed air passing between said air inlet and said air outlet upon rotation of said control socket relative to said air connector.

2. The flow control device as claimed in claim 1, wherein said flow-control seal is mounted in said control socket.

3. The flow control device as claimed in claim 2, wherein said air connector has an air passage in communication between said air inlet and said air outlet.

4. The flow control device as claimed in claim 2, wherein said control socket has an air passage in communication between said air inlet and said air outlet.

5. The flow control device as claimed in claim 4, wherein said flow-control seal is mounted in said air passage of said control socket and driven by said control socket to control the flow rate of a compressed air passing from said air inlet to said air outlet.

6. The flow control device as claimed in claim 2, wherein said air connector further has a second male screw portion; said control socket further has a second female screw portion threaded onto said second male screw portion.

7. The flow control device as claimed in claim 1, wherein said flow-control seal is mounted in said air connector.

8. The flow control device as claimed in claim 7, wherein said air connector has an annular groove extending around the periphery thereof adapted to receive said flow-control seal.

9. The flow control device as claimed in claim 7, wherein said flow-control seal is mounted in one end of said air inlet in the periphery of said air connector, having a through hole for the passing of a compressed air from said air inlet to said air outlet.

10. The flow control device as claimed in claim 7, wherein said air connector further has a second male screw portion; said control socket further has a second female screw portion threaded onto said second male screw portion.
